(19) United States
(12) Patent Application Publication
(10) Pub. No.: US 2009/0267345 A1
(43) Pub. Date: Oct. 29, 2009

(54) PIPE COUPLING DEVICES

(76) Inventor: Yuk Nam Choi, Gyeonggi-do (KR)

Correspondence Address: NOTARO & MICHALOS P.C., 100 DUTCH HILL ROAD, SUITE 110, ORANGEBURG, NY, 10962-2100, US

(21) Appl. No.: 12/513,599

(22) PCT Filed: Jun. 13, 2007
(86) PCT No.: PCT/KR2007/002855

§ 371 Date: Jun. 26, 2009

(30) Foreign Application Priority Data
Nov. 7, 2006 (KR) 20-2006-0029211

(51) Int. Cl. F16L 37/00

(52) U.S. Cl. 285/309

(57) ABSTRACT

Disclosed are coupling devices for joining and connecting pipes. The pipe coupling devices comprise a housing formed with a penetrating hole therein to connect pipes, covers fastened to the housing, and compression elements coupled to the respective covers to compress the outer circumferential surfaces of the pipes and hermetically fix the pipes to the housing.

### TECHNICAL FIELD

The present invention relates to pipe coupling devices. More specifically, the present invention relates to pipe coupling devices that are designed to improve the assembled state of respective constituent elements to maintain hermetic joining and connection of pipes, and designed to enable visual recognition of the specified dimension of the pipe coupling devices and visual checking of the coupled state between the pipes and the pipe coupling devices by colors.

### BACKGROUND ART

Piping work refers collectively to all types of work wherein pipes having a prescribed length are cut and connected together according to various installation environments to produce a pipeline. Due to limited length of the pipes and the necessity to change the direction of the pipeline during piping work, pipe coupling devices are currently in use.

Main applications of pipes are water supply and drainage lines for the transport of water and hydraulic lines for the transport of fluids (e.g., oils). In addition, pipes are used to transport gases and various raw materials (e.g., powders).

When it is intended to produce a long transport line, a number of coupling sites are required in the middle of the transport line due to limited length of pipes used to produce the transport line. Coupling structures capable of maintaining hermetic sealing of the transport line are also required at the coupling sites to prevent leakage from the transport line.

In connection with the prior art, Korean Registered Utility Model No. 0381923 suggests a pipe coupling device shown in FIG. 1. Specifically, the pipe coupling device comprises: a hollow body 10 formed with a number of connecting openings 11 into which pipes 70 are inserted; fixing units 20, each of which includes a number of inwardly inclined fixing pieces 21 for compressing the outer circumferential surface of the corresponding pipe 70 inserted into the corresponding connecting opening 11 to fix the pipe 70 thereto; support rings 30, each of which is inserted within the corresponding connecting opening 11 to be securely mounted in the corresponding fixing unit 20, the pipe 70 being inserted into and fixed to the corresponding support ring 30; packing members 40, each of which is installed at the outer lateral end of the corresponding connecting opening 11 and adhered to the corresponding support ring 30 to ensure hermetic sealing of the corresponding pipe connected to the body 10; and locking nuts 50, each of which has an internal thread 60 armed therein and is fastened to the end portion of the corresponding connecting opening 11 via the thread to be adhered and fixed to the corresponding packing member 40, the elements 20, 30, 40 and 50 being configured to be sequentially installed to the body 10, wherein the body 10 includes a stepped portion 12 formed at its inner side such that fixing units 20 are stably seated and an inclined stepped portion 13 extending from its inner end at the same angle as the fixing pieces 21.

According to this configuration of the prior art pipe coupling device, the fixing units 20 are installed to the stepped portion 12 of the body 10, the support rings 30 serve to support and fix the respective support rings 30, the locking nuts 50 are fastened to the body 10, and the pipes 70 are inserted into the pipe coupling device.

Due to the inclined fixing pieces 21 of the respective fixing units 20, the pipes 70 are smoothly inserted into the pipe coupling device but are not easily withdrawn from the pipe coupling device. As a result, the pipes 70 are fixedly connected to the body 10.

However, the connected state of the pipes by the prior art pipe coupling device is not stable, causing the problems of easy withdrawal of the pipes from the coupling device and insufficient hermetic sealing of the pipes. When a fluid is transported through the pipes under high pressure, poor coupling between the pipes and the coupling device and insufficient hermetic sealing of the pipes cause leakage of the fluid.

The pipes are introduced inside the body and then the locking nuts are fastened to the body by means of the threads. However, after the coupling device and the pipes are exposed to vibration or remain coupled for a long period of time, the fastened state between the body and the locking nuts is loosened, resulting in leakage of a fluid from the pipes.

On the other hand, the diameter of pipes for piping work is determined depending on the purpose of use. Here, the diameter of coupling devices applied to the pipes having different diameters must be checked using a suitable dimension measuring instrument, such as a vernier calliper or a micrometer, which makes the piping work inefficient.

### DISCLOSURE OF INVENTION

### Technical Problem

It is a principal object of the present invention to provide a coupling device comprising a housing and elastically expandable compression elements coupled to the housing so that pipes can be hermetically fixed to the coupling device, thereby preventing leakage of a fluid from the pipes and enabling coupling of the pipes to the coupling device in an easier manner.

It is another object of the present invention to provide a coupling device comprising a housing and covers hermetically fastened to the housing without loosening to further maximize the fixing force of pipes to the coupling device.

It is another object of the present invention to provide a coupling device comprising a housing, covers fastened to the housing, and specification identification rings, which are colored according to the diameter of pipes, mounted on outer circumferences of the covers and the compression elements to visually discern the specified dimension of the coupling device by colors.

It is another object of the present invention to provide a coupling device comprising a housing, covers fastened to the housing, and coupling identification rings, which are colored according to the specified size of pipes, mounted on the covers, so that whether or not the covers are completely fastened to the housing can be judged by visually checking the coupling identification rings exposed to the outside.

It is yet another object of the present invention to provide a coupling device comprising a housing formed with a penetrating hole therein, snap rings coupled to pipes, and sealing members accommodated therein wherein the sealing members are deformed in shape by a compressive force of the snap rings generated upon coupling of the pipes to be adhered to the penetrating hole and outer circumferences of the pipes, resulting in a further improvement in the leakage preventive function of the coupling device.

### Technical Solution

In accordance with a first aspect of the present invention for achieving the above objects, there is provided a pipe coupling device, comprising:

a housing formed with a multi-stepped penetrating hole at its center, male screws at both ends of its outer circumferential surface, and a plurality of continuous latch projections on its outer circumference behind the respective male screws;

covers, each of which is formed with a female screw on its inner circumferential surface to be fastened to the corresponding male screw of the housing, a coupling hole at its center to be communicated with the penetrating hole, a plurality of fixing projections on its inner circumference to compress and be engaged with the latch projections after being fastened to the housing while maintaining hermetic coupling with the housing, and a stepped portion at a boundary between the female screw and the penetrating hole; and

compression elements, each of which is formed with a compression hole therein to be introduced into the coupling hole of the corresponding cover, a flare portion at one side of its outer circumferential surface, a flange integrated with the flare portion and formed with slits therein to be elastically expanded, and a plurality of latch steps at the other side of its outer circumferential surface so that the latch steps can be latched by the stepped portion of the corresponding cover to compress the circumferential surface of a pipe fitted into the compression hole.

In accordance with a second aspect of the present invention, there is provided a pipe coupling device, comprising:

a housing formed with a multi-stepped penetrating hole at its center, male screws at both ends of its outer circumferential surface, first stepped portions protruding outwardly from its outer circumference behind the respective male screws, and a plurality of continuous sealing projections on an upper surface of each of the first stepped portions;

covers, each of which is formed with a female screw on its inner circumferential surface to be fastened to the corresponding male screw of the housing, a coupling hole at its center to be communicated with the penetrating hole, a plurality of friction projections at its end portion where the coupling hole is opened to form a latch structure with the sealing projections after being fastened to the housing while maintaining hermetic coupling with the housing, and a stepped portion at a boundary between the female screw and the penetrating hole; and

compression elements, each of which is formed with a compression hole therein to be introduced into the coupling hole of the corresponding cover, a flare portion at one side of its outer circumferential surface, a flange integrated with the flare portion and formed with slits therein to be elastically expanded, and a plurality of latch steps at the other side of its outer circumferential surface so that the latch steps can be latched by the stepped portion of the corresponding cover to compress the circumferential surface of a pipe fitted into the compression hole.

In an embodiment of the present invention, the plurality of latch projections are continuously formed on an outer circumference of the housing behind the respective male screws, curved to have a rounded top shape, and arranged in a row; and the plurality of fixing projections are continuously formed on an inner circumference of the respective covers, inclined in a predetermined direction, i.e. in a rotational direction to be fastened to the latch projections, and arranged in a row such that the fixing projections compress the latch projections and the edges of the fixing projections are partially engaged with boundaries between the latch projections when the housing is fastened to the covers.

In a further embodiment of the present invention, the coupling device further comprises coupling grooves formed on outer circumferences of the covers and the housing, annular specification identification rings coupled to the respective coupling grooves, one portion of each of the specification identification rings being cut away so as not to allow both ends of the specification identification ring to be connected to each other, and coupling identification rings coupled to outer circumferences of the housing in a lateral direction of the respective male screws wherein the surfaces of the specification identification rings and the coupling identification rings are colored rainbow colors, such as red, orange, yellow, green, blue, indigo and violet, so that the specified size of pipes can be recognized by the colors of the specification identification rings mounted on the coupling grooves of the respective covers and the coupled state between the covers and the housing can be visually checked by the coupling identification rings mounted on outer circumferences of the housing in a lateral direction of the respective male screws.

In another embodiment of the present invention, the coupling device further comprises sealing members accommodated in the penetrating hole of the housing and snap rings coupled to outer circumferences of pipes wherein the sealing members provided between the pipes and the penetrating hole are deformed in shape by a compressive force of the snap rings generated upon coupling of the pipes to be adhered to the penetrating hole and outer circumferences of the pipes, resulting in a further improvement in the leakage preventive function of the coupling device.

In another embodiment of the present invention, the pipe coupling device further comprises specification identification rings, each being coupled to the coupling hole of the corresponding cover to be disposed between one end of the corresponding cover and the flare portion of the corresponding compression element.

In an embodiment of the second aspect of the present invention, the pipe coupling device further comprises mounting grooves formed at ends of the outer circumferential surface of the coupling hole of the corresponding cover, coupling identification rings coupled to the respective mounting grooves, and jaws extending upward from the ends of the respective first stepped portions of the housing so that the coupling identification rings coupled to the respective mounting grooves are introduced into inner circumferential surfaces of the respective extended jaws when the housing is coupled to the covers.

In a further embodiment of the second aspect of the present invention, the sealing projections are fastened to the friction projections to form upwardly inclined faces, which are symmetric with respect to one another in a fastening direction, and the inclined faces are formed at right angles after their peaks so that a hermetic latch structure of the sealing projections and the friction projections can be maintained by hermetic coupling of the housing to the covers.

### Advantageous Effects

As apparent from the above description, according to the pipe coupling device of the present invention, the elastically expandable compression elements are coupled to the housing such that pipes can be hermetically fixed to the coupling device, thereby preventing leakage of a fluid from the pipes and enabling coupling of the pipes to the coupling device in an easier manner.

In addition, the covers are hermetically fastened to the housing without loosening to further improve the fixing force of pipes to the coupling device and maximize the prevention of water leakage from the pipes.

Further, since specification identification rings, which are colored according to the diameter of pipes are mounted on outer circumferences of the covers and the compression elements, the specified dimension of the coupling device can be visually discerned by colors.

Furthermore, coupling identification rings, which are colored according to the specified size of pipes, are mounted on the respective covers such that whether or not the covers are completely fastened to the housing can be judged by visually checking the coupling identification rings exposed to the outside.

Moreover, snap rings are coupled to pipes and sealing members are accommodated in the coupling device such that the sealing members are deformed in shape by a compressive force of the snap rings generated upon coupling of the pipes to be adhered to a penetrating hole formed within the housing and outer circumferences of the pipes, resulting in a further improvement in the leakage preventive function of the coupling device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a prior art pipe coupling device;

FIG. 2 is a perspective view showing an assembled state of a pipe coupling device according to a first aspect of the present invention;

FIG. 3 is an exploded perspective view of a pipe coupling device according to a first aspect of the present invention;

FIG. 4 is a cross-sectional view showing an assembled state of a pipe coupling device according to a first aspect of the present invention;

FIG. 5 is an exploded cross-sectional view of a pipe coupling device according to a first aspect of the present invention;

FIG. 6 is a cross-sectional view showing a state in which a pipe coupling device according to a first aspect of the present invention is used;

FIG. 7 shows perspective views of specification identification rings that can be used in pipe coupling devices of the present invention;

FIG. 8 is an exploded perspective view of a pipe coupling device according to a second aspect of the present invention;

FIG. 9 is a cross-sectional view of a pipe coupling device according to a second aspect of the present invention; and

FIGS. 10 and 11 are enlarged cross-sectional views showing two structures in which a housing is fastened to covers in a pipe coupling device according to a second aspect of the present invention.

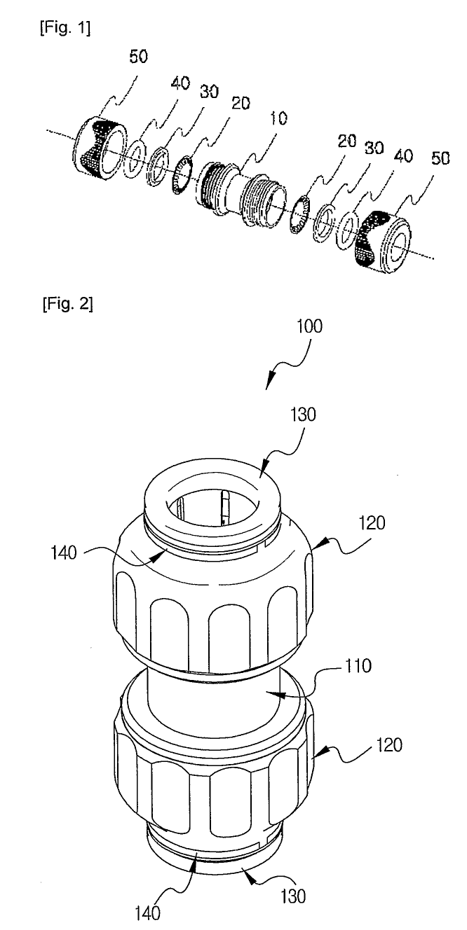

### BEST MODE FOR CARRYING OUT THE INVENTION

It should be noted that, wherever possible, the same reference numerals represent the same elements or parts throughout the drawings. For the purpose of clarity, a detailed description of known functions and configurations incorporated herein will be omitted as they may make the subject matter of the present invention unclear.

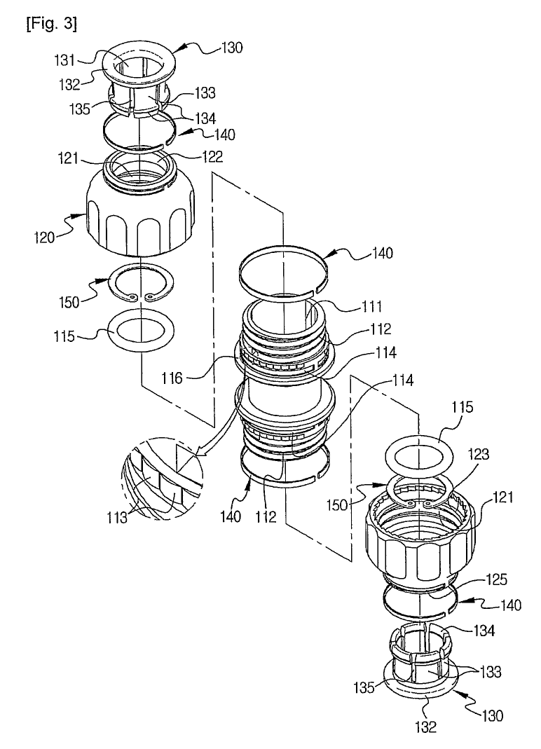

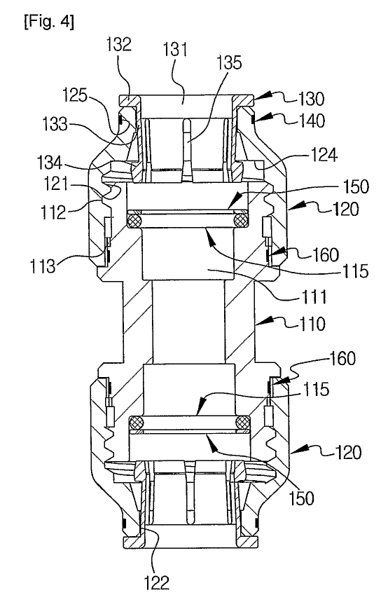

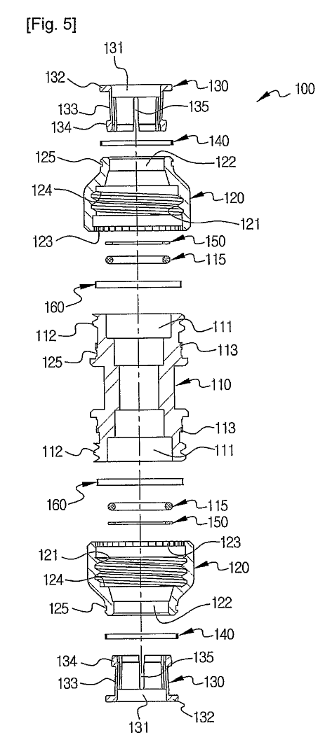

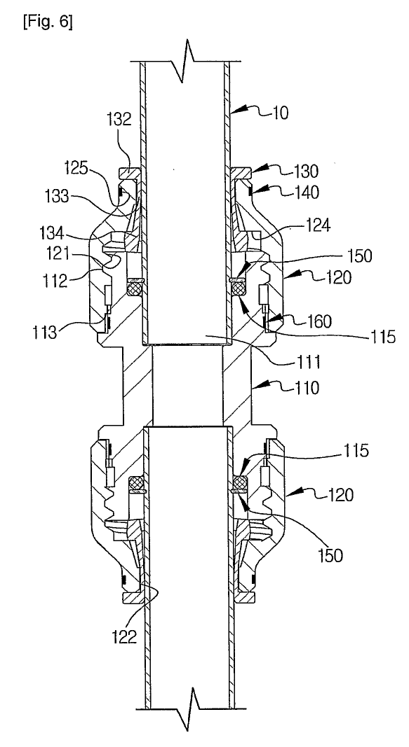

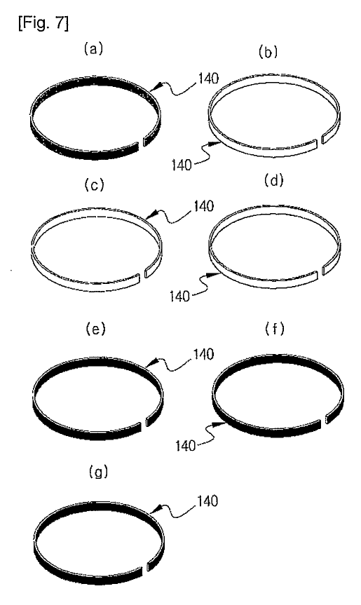

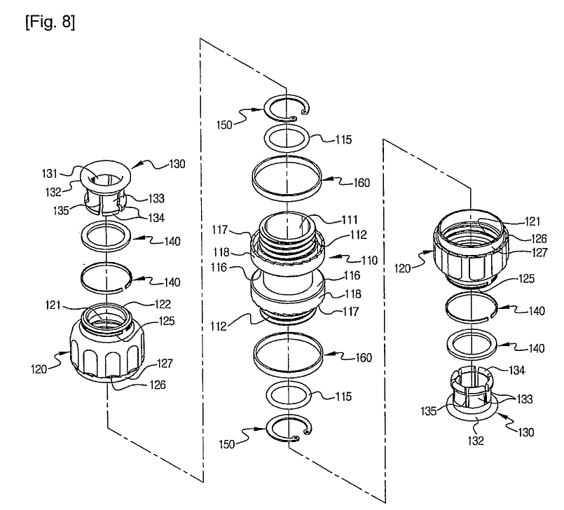

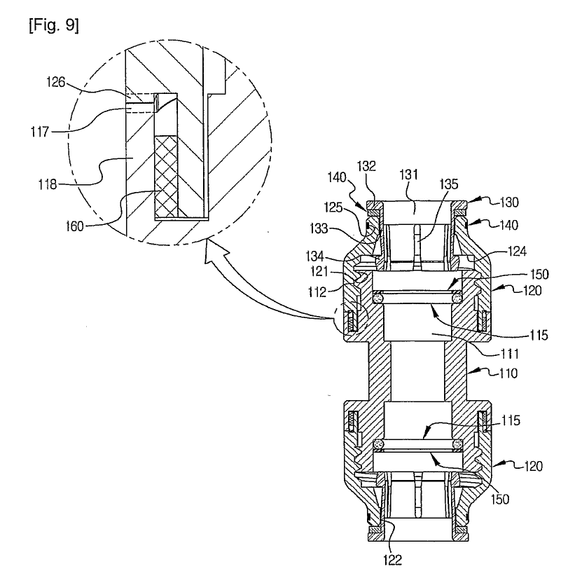

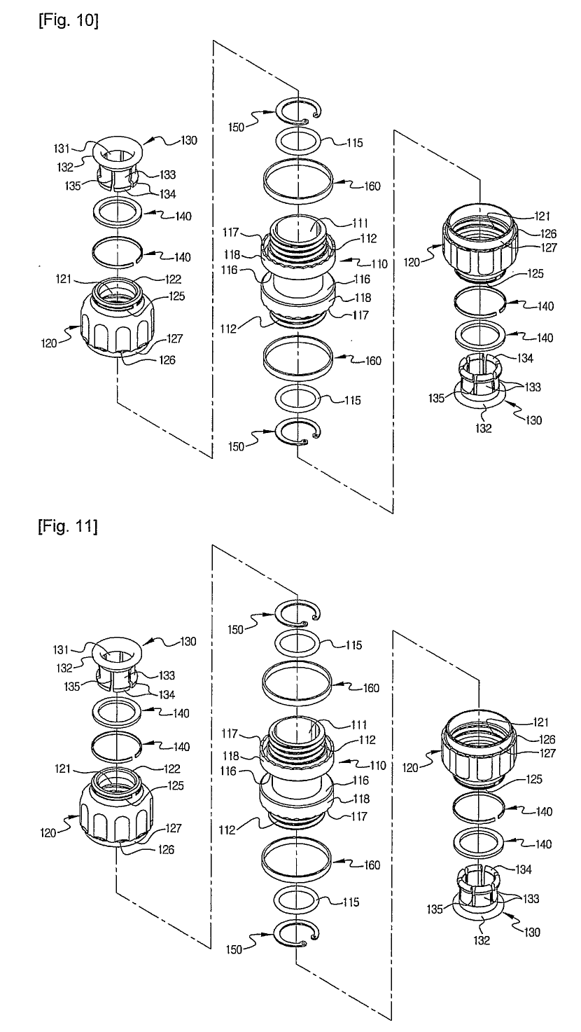

FIG. 2 is a perspective view showing an assembled state of a pipe coupling device according to a first aspect of the present invention, FIG. 3 is an exploded perspective view of a pipe coupling device according to a first aspect of the present invention, FIG. 4 is a cross-sectional view showing an assembled state of a pipe coupling device according to a first aspect of the present invention, FIG. 5 is an exploded cross-sectional view of a pipe coupling device according to a first aspect of the present invention, FIG. 6 is a cross-sectional view showing a state in which a pipe coupling device according to a first aspect of the present invention is used, FIG. 7 shows perspective views of specification identification rings that can be used in pipe coupling devices of the present invention, FIG. 8 is an exploded perspective view of a pipe coupling device according to a second aspect of the present invention, FIG. 9 is a cross-sectional view of a pipe coupling device according to a second aspect of the present invention, and FIGS. 10 and 11 are enlarged cross-sectional views showing two structures in which a housing is fastened to covers in a pipe coupling device according to a second aspect of the present invention.

First, as shown in FIGS. 2 to 6, the pipe coupling device 100 according to a first aspect of the present invention comprises a housing 110 for joining and connecting both ends of a pair of pipes 10 to be communicated to each other, covers 120 fastened to both end portions of the housing 110, and compression elements 130 coupled to both ends of the housing 110 to elastically fix the outer circumferential surfaces of the pipes 10.

The housing 110 is formed with a multi-stepped penetrating hole 111 at its center, male screws 112 at both ends of its outer circumferential surface, and a plurality of continuous latch projections 113 on its outer circumference behind the respective male screws 112.

Each of the covers 120 is formed with a female screw 121 on its inner circumferential surface to be fastened to the corresponding male screw 112 of the housing 110, a coupling hole 122 at its center to be communicated with the penetrating hole 111, a plurality of fixing projections 123 on its inner circumference to compress and be engaged with the latch projections 113 after being fastened to the housing while maintaining hermetic coupling with the housing 110, and a stepped portion 124 at the boundary between the female screw 121 and the penetrating hole 111.

The plurality of latch projections 113 are continuously formed on the outer circumference of the housing 110 behind the respective male screws 112, curved to have a rounded top shape, and arranged in a row.

The plurality of fixing projections 123 are continuously formed on the inner circumference of the respective covers 120, inclined in a predetermined direction, i.e. in a rotational direction to be fastened to the latch projections 113, and arranged in a row such that the fixing projections 123 compress the latch projections 113 and the edges of the fixing projections 123 are partially engaged with the recessed boundaries of the latch projections 113 when the housing 110 is fastened to the covers 120.

Each of the compression elements 130 is formed with a compression hole 131 therein to be introduced into the coupling hole 122 of the corresponding cover 120, a flare portion 132 at one side of its outer circumferential surface, a flange 133 integrated with the flare portion 132 and armed with slits 135 therein to be elastically expanded, and a plurality of latch steps 134 at the other side of its outer circumferential surface so that the latch steps 134 can be latched by the stepped portion 124 of the corresponding cover 120 to compress the circumferential surface of a pipe 10 fitted into the compression hole 131.

The coupling device 100 further comprises sealing members 115 accommodated in the penetrating hole 111 of the housing and snap rings 150 coupled to the outer circumferences of pipes 10 wherein the sealing members 115 provided between the pipes 10 and the penetrating hole 111 are deformed in shape by a compressive force of the snap rings 150 generated upon coupling of the pipes 10 to be adhered to the penetrating hole 111 and the outer circumferences of the pipes 10, resulting in a further improvement in the leakage preventive function of the coupling device 100.

The coupling device 100 further comprises coupling grooves 114 and 125 formed on the outer circumferences of the covers 120 and the housing 110, annular specification identification rings 140 mounted to the respective coupling grooves 114 and 125, one portion of each of the specification identification rings 140 being cut away so as not to allow both ends of the specification identification ring 140 to be connected to each other wherein the surfaces of the specification identification rings 140 are colored rainbow colors, such as red, orange, yellow, green, blue, indigo and violet, so that the specified size of pipes can be recognized by the colors of the specification identification rings 140 mounted on the coupling grooves 114 of the respective covers 120 and the coupled state between the covers 120 and the housing 110 can be visually checked by the specification identification rings 140 mounted on the coupling grooves 114 of the housing 110.

The specification of the coupling device 100 is varied depending on the diameter of the pipes 10.

For example, when it is intended to join and connect the pipes 10 having a diameter of Φ100 to each other, the compression holes 131 of the coupling device 100 must have a diameter of Φ100. Accordingly, the prior art pipe coupling device suffers from the inconvenience that the inner diameters of the compression holes 131 of the coupling device 100 having the same specification as the pipes 10 must be checked one by one using a suitable dimension measuring instrument, such as a vernier calliper or a micrometer. In contrast, according to the pipe coupling device of the present invention, since the specification identification rings 140 mounted in the respective covers 120 are colored rainbow colors, such as red, orange, yellow, green, blue, indigo and violet, depending on the diameter of the pipes 10, the specification (i.e. the diameter of the compression holes) of the coupling device 100 can be visually recognized in an easy manner by the colors of the specification identification rings 140.

When the covers 120 are coupled to the housing 110 through the specification identification rings 140 of the housing 110, the covers 120 are shifted along the housing 110 to conceal the respective specification identification rings 140 by the inner circumferences of the covers 120, which enables visual checking whether the housing 110 is hermetically coupled to the covers 120 or not.

Here, the specification identification rings 140 can be colored red, orange, yellow, green, blue, indigo and violet depending on the specification of the pipes 10, for example, with increasing diameter of the pipes 10. As a result, the specification of the coupling device 100 can be visually judged in an easier manner by the colors of the specification identification rings 140.

As shown in FIGS. 8 and 9, the pipe coupling device 100 according to a second aspect of the present invention comprises: a housing 110 formed with a multi-stepped penetrating hole 111 at its center, male screws 112 at both ends of its outer circumferential surface, first stepped portions 116 protruding outwardly from its outer circumference behind the respective male screws 112, and a plurality of continuous sealing projections 117 on the upper surface of each of the first stepped portions 116, covers 120, each of which is formed with a female screw 121 on its inner circumferential surface to be fastened to the corresponding male screw 112 of the housing 110, a coupling hole 122 at its center to be communicated with the penetrating hole 111, a plurality of friction projections 126 at its end portion where the coupling hole 122 is opened to form a latch structure with the sealing projections 117 after being fastened to the housing 110 while maintaining hermetic coupling with the housing 110, and a stepped portion 124 at the boundary between the female screw 121 and the penetrating hole 111; and compression elements 130, each of which is formed with a compression hole 131 therein to be introduced into the coupling hole 122 of the corresponding cover 120, a flare portion 132 at one side of its outer circumferential surface, a flange 133 integrated with the flare portion 132 and formed with slits 135 therein to be elastically expanded, and a plurality of latch steps 134 at the other side of its outer circumferential surface so that the latch steps 134 can be latched by the stepped portion 124 of the corresponding cover 120 to compress the circumferential surface of a pipe 100 fitted into the compression hole 131.

Specifically, according to the pipe coupling device 100, the plurality of sealing projections 117 are continuously formed on the upper surface of the first stepped portions 116 of the housing 110, and the plurality of friction projections 126 are formed at portions of the respective covers 120, which come into contact with the sealing projections 117 when the housing 110 is fastened to the covers 120, so that the sealing projections 117 are coupled to the friction projections 126 to form a latch structure, thus achieving hermetic fixing of the housing 110 to the covers 120.

The pipe coupling device 100 further comprises mounting grooves 127 formed at ends of the outer circumferential surface of the coupling hole 122 of the corresponding cover 120, coupling identification rings 160 coupled to the respective mounting grooves 127, and jaws 118 extending upward from the ends of the respective first stepped portions 116 of the housing 110 so that the coupling identification rings 160 coupled to the respective mounting grooves 127 are introduced into the inner circumferential surfaces of the respective extended jaws 118 when the housing 110 is coupled to the covers 120.

The sealing projections 117 are fastened to the friction projections 126 to form upwardly inclined faces, which are symmetric with respect to one another in a fastening direction, and the inclined faces are formed at right angles after their peaks so that a hermetic latch structure of the sealing projections 117 and the friction projections 126 can be maintained by hermetic coupling of the housing 110 to the covers 120.

As shown in FIGS. 10 and 11, the sealing projections 117 and the friction projections 126 formed in the housing 110 and the covers 120, respectively, may have a triangular, semi-arc or polygonal cross section.

The pipe coupling device 100 further comprises specification identification rings 140, each being coupled to the corresponding coupling hole 122 to be disposed between one end of the corresponding cover 120 and the flare portion of the corresponding compression element.

### Mode for the Invention

The operations of the coupling devices according to the present invention will be explained below.

With reference firstly to FIGS. 2 to 6, an explanation of a method for joining and connecting pipes 10 through the coupling device 100 will be given below.

Sealing members 115 are accommodated within a penetrating hole 111 of the housing 110 and the covers 120, in which the respective compression elements 130 are mounted, are fastened to the housing 110.

At the time when the fastening of male screws 112 of the housing 110 to female screws 121 of the respective covers 120 is finished, fixing projections 123 formed obliquely in one direction in the covers 120 compress the upper surfaces of latch projections 113 of the housing 110, and concurrently, the apex edges of the fixing projections 123 are engaged with grooves defined at the boundaries between the rounded latch projections 113. As a result, the housing 110 is hermetically fixed to the covers 120.

Alternatively, with reference to FIGS. 8 and 9, at the time when the fastening of male screws 112 of the housing 110 to female screws 121 of the respective covers 120 is finished, friction projections 126 of the covers 120 are rotated in a vertical downward direction with respect to sealing projections 117 formed on the upper surfaces of respective first stepped portions of the housing to be engaged with the sealing projections 117 due to the symmetrically curved shapes of the projections. As a result, the housing 110 can be hermetically fixed to the covers 120.

Further, as the coupling of the housing 110 to the covers 120 proceeds, colored coupling identification rings 160 coupled to mounting grooves 127 of the respective covers 120 are gradually introduced into the inner circumferential surfaces of extended jaws 118 of the housing 110. After completion of the coupling of the housing 110 to the covers 120, the coupling identification rings 160 cannot be visualized from the outside.

In conclusion, the complete coupling of the housing 110 to the covers 120 can be easily judged by checking whether or not the coupling identification rings 160 coupled to the mounting grooves 127 of the respective covers 120 is visualized from the outside.

After the housing 110 is completely coupled to the covers 120, pipes 10 are coupled to respective snap rings 150 at their outer circumferences and are fitted into the penetrating hole 111 of the housing 110. Here, flanges 133 of the respective compression elements 130 are elastically expanded to position latch steps 134 at stepped portions 124 of the respective covers 120, so that the coupling of the covers 120 to the respective compression elements 130 is maintained, and at the same time, the pipes 10 forcibly fitted into the inner circumferences of compression holes 131 of the respective compression elements 130 are hermetically fixed to the coupling device 100.

The snap rings 150 coupled to the respective pipes 10 compress sealing members 115 accommodated in the penetrating hole 111 of the housing 110 to deform the shape of the sealing members 115 provided between the pipes 10 and the penetrating hole 111 and to adhere the sealing members 115 to the penetrating hole 111 and the outer circumferences of the pipes 10, resulting in a further improvement in the leakage preventive function of the coupling device 100.

In addition, annular specification identification rings 140 are coupled to coupling grooves 125 of the housing 110 and the covers 120, one portion of each of the specification identification rings being cut away so as not to allow both ends of the specification identification ring to be connected to each other, to be elastically expandable. Also, other specification identification rings 140 are coupled to coupling holes 122 of the respective covers 120 such that each of the specification identification rings is disposed between one end of the corresponding cover 120 and the flare portion 132 of the corresponding compression element 130. As a result, the specification of the coupling device for connecting the pipes 10 having different sizes can be determined depending on the colors of the specification identification rings 140, contributing to an improvement in the efficiency of piping work.

The foregoing embodiments and accompanying drawings do not serve to limit the scope of the present invention. Accordingly, those skilled in the art will appreciate that various substitutions, modifications and changes are possible, without departing from the technical spirit of the present invention as disclosed in the accompanying claims.

1: A coupling device for joining and connecting pipes, comprising:
a housing formed with a multi-stepped penetrating hole at its center, male screws at both ends of its outer circumferential surface, and a plurality of continuous latch projections on its outer circumference behind the respective male screws;
covers, each of which is formed with a female screw on its inner circumferential surface to be fastened to the corresponding male screw of the housing, a coupling hole at its center to be communicated with the penetrating hole, a plurality of fixing projections on its inner circumference to compress and be engaged with the latch projections after being fastened to the housing while maintaining hermetic coupling with the housing, and a stepped portion at a boundary between the female screw and the penetrating hole; and
compression elements, each of which is formed with a compression hole therein to be introduced into the coupling hole of the corresponding cover, a flare portion at one side of its outer circumferential surface, a flange integrated with the flare portion and formed with slits therein to be elastically expanded, and a plurality of latch steps at the other side of its outer circumferential surface such that the latch steps are latched by the stepped portion of the corresponding cover to compress the circumferential surface of a pipe fitted into the compression hole.

2: A coupling device for joining and connecting pipes, comprising:
a housing formed with a multi-stepped penetrating hole at its center, male screws at both ends of its outer circumferential surface, first stepped portions protruding outwardly from its outer circumference behind the respective male screws, and a plurality of continuous sealing projections on an upper surface of each of the first stepped portions;
covers, each of which is formed with a female screw on its inner circumferential surface to be fastened to the corresponding male screw of the housing, a coupling hole at its center to be communicated with the penetrating hole, a plurality of friction projections at its end portion where the coupling hole is opened to form a latch structure with the sealing projections after being fastened to the housing while maintaining hermetic coupling with the housing, and a stepped portion at a boundary between the female screw and the penetrating hole; and
compression elements, each of which is formed with a compression hole therein to be introduced into the coupling hole of the corresponding cover, a flare portion at one side of its outer circumferential surface, a flange integrated with the flare portion and formed with slits therein to be elastically expanded, and a plurality of latch steps at the other side of its outer circumferential surface such that the latch steps are latched by the stepped portion of the corresponding cover to compress the circumferential surface of a pipe fitted into the compression hole.

3: The coupling device according to claim 1, wherein the plurality of latch projections are continuously formed on an outer circumference of the housing behind the respective male screws, curved to have a rounded top shape, and arranged in a row; and the plurality of fixing projections are continuously formed on an inner circumference of the respective covers, inclined in a predetermined direction, i.e. in a rotational direction to be fastened to the latch projections, and arranged in a row such that the fixing projections compress the latch projections and the edges of the fixing projections are partially engaged with boundaries between the latch projections when the housing is fastened to the covers.

4: The coupling device according to claim 2, wherein the plurality of sealing projections are continuously formed on an outer circumference of the housing behind the respective male screws, curved to have a rounded top shape, and arranged in a row; and the plurality of friction projections are continuously formed on an inner circumference of the respective covers, inclined in a predetermined direction, i.e. in a rotational direction to be fastened to the sealing projections, and arranged in a row such that the friction projections compress the sealing projections and the edges of the friction projections are partially engaged with boundaries between the sealing projections when the housing is fastened to the covers.

5: The coupling device according to claim 1, further comprising coupling grooves formed on outer circumferences of the covers and the housing, annular specification identification rings coupled to the respective coupling grooves, one portion of each of the specification identification rings being cut away so as not to allow both ends of the specification identification ring to be connected to each other, and coupling identification rings coupled to outer circumferences of the housing in a lateral direction of the respective male screws, the surfaces of the specification identification rings and the coupling identification rings being colored rainbow colors, including red, orange, yellow, green, blue, indigo and violet, so that the specified size of pipes is recognized by the colors of the specification identification rings mounted on the coupling grooves of the respective covers and the coupled state between the covers and the housing is visually checked by the coupling identification rings mounted on outer circumferences of the housing in a lateral direction of the respective male screws.

6: The coupling device according to claim 1, further comprising sealing members accommodated in the penetrating hole of the housing and snap rings coupled to outer circumferences of pipes so that the sealing members provided between the pipes and the penetrating hole are deformed in shape by a compressive force of the snap rings generated upon coupling of the pipes to be adhered to the penetrating hole and outer circumferences of the pipes, resulting in a further improvement in the leakage preventive function of the coupling device.

7: The coupling device according to claim 1, further comprising specification identification rings, each being coupled to the coupling hole of the corresponding cover to be disposed between one end of the corresponding cover and the flare portion of the corresponding compression element.

8: The coupling device according to claim 2, further comprising mounting grooves formed at ends of the outer circumferential surface of the coupling hole of the corresponding cover, coupling identification rings coupled to the respective mounting grooves, and jaws extending upward from the ends of the respective first stepped portions of the housing so that the coupling identification rings coupled to the respective mounting grooves are introduced into inner circumferential surfaces of the respective extended jaws when the housing is coupled to the covers.

9: The coupling device according to claim 2, wherein the sealing projections are fastened to the friction projections to form upwardly inclined faces, which are symmetric with respect to one another in a fastening direction, and the inclined faces are formed at right angles after their peaks so that a hermetic latch structure of the sealing projections and the friction projections is maintained by hermetic coupling of the housing to the covers.
